(19) United States
(12) Patent Application Publication
(10) Pub. No.: US 2026/0221894 A1
(43) Pub. Date: Jul. 30, 2026

(54) POWER CONVERTER FOR VEHICLE CHARGING

(71) Applicant: GM Global Technology Operations LLC, Detroit, MI (US)

(72) Inventors: Yilun Luo, Ann Arbor, MI (US); Minh-Khai Nguyen, Troy, MI (US); Lei Hao, Shelby Township, MI (US); Dongxu Li, Troy, MI (US); Firas Shabo, Shelby Township, MI (US); Mohammad N. Anwar, Northville, MI (US)

(21) Appl. No.: 19/036,645

(22) Filed: Jan. 24, 2025

(51) Int. Cl. H02M 7/219; B60L 53/22; H02M 1/00

(52) U.S. Cl. CPC H02M 7/219; B60L 53/22; H02M 1/0064; H02M 1/0083; B60L 2210/30

(57) ABSTRACT

A power converter may include a primary side having a line connection port and a plurality of semiconductor switches and a secondary side having one or more alternating current (AC) to direct current (DC) converters and one or more load connection ports. The power converter further may include one or more transformers configured to transfer power between the primary side and the secondary side.

### INTRODUCTION

The present disclosure relates to apparatuses and systems for power conversion for electric vehicles.

To enable efficient battery charging in electric vehicle (xEV) applications, on-board charging modules (OBCMs) may be utilized. On-board charging modules are integrated power-electronic systems typically including semiconductor switches configured to be controllable to accomplish charging tasks such as, for example, alternating current (AC) to direct current (DC) conversion, voltage regulation, and/or the like. In some examples, on-board charging modules are configured with a bidirectional design to allow not only battery charging but also energy feedback to the grid or auxiliary systems. In some examples, on-board charging modules incorporate thermal management systems to ensure reliable operation under varying environmental conditions, such as extreme temperatures. Furthermore, on-board charging modules may include communication interfaces to interact with external charging stations, enabling power adjustments and optimized charging profiles based on to the battery's state of health and state of charge.

While apparatuses and systems for power conversion achieve their intended purpose, there is a need for a new and improved power converter for charging electric vehicles.

### SUMMARY

According to several aspects, a power converter is provided. The power converter may include a primary side having a line connection port and a plurality of semiconductor switches and a secondary side having one or more alternating current (AC) to direct current (DC) converters and one or more load connection ports. The power converter further may include one or more transformers configured to transfer power between the primary side and the secondary side.

In another aspect of the present disclosure, the line connection port may include two or more of: a first AC phase connection, a second AC phase connection, a third AC phase connection, and a neutral AC connection. The line connection port further may include a plurality of electrically controllable switches in electrical communication with the first AC phase connection, the second AC phase connection, the third AC phase connection, and the neutral AC connection.

In another aspect of the present disclosure, the plurality of semiconductor switches further may include one or more switch pairs. A first switch of each of the one or more switch pairs is connected between a first terminal of a first primary winding of one or more primary windings of the one or more transformers and a switch pair common node. A second switch of each of the one or more switch pairs is connected between a second terminal of the first primary winding of the one or more primary windings of the one or more transformers and the switch pair common node. The switch pair common node is in electrical communication with the line connection port.

In another aspect of the present disclosure, the one or more switch pairs further may include a first switch pair connected between the first terminal of the first primary winding and the second terminal of the first primary winding and having a first switch pair common node in electrical communication with the first AC phase connection. The one or more switch pairs further may include a second switch pair connected between the first terminal of the first primary winding and the second terminal of the first primary winding and having a second switch pair common node in electrical communication with the second AC phase connection. The one or more switch pairs further may include a third switch pair connected between the first terminal of the first primary winding and the second terminal of the first primary winding and having a third switch pair common node in electrical communication with the third AC phase connection. The one or more switch pairs further may include a fourth switch pair connected between the first terminal of the first primary winding and the second terminal of the first primary winding and having a fourth switch pair common node in electrical communication with the neutral AC connection.

In another aspect of the present disclosure, the plurality of electrically controllable switches further may include a first electrically controllable switch connected between the first AC phase connection and the first switch pair common node. The plurality of electrically controllable switches further may include a second electrically controllable switch connected between the second AC phase connection and the second switch pair common node. The plurality of electrically controllable switches further may include a third electrically controllable switch connected between the third AC phase connection and the third switch pair common node. The plurality of electrically controllable switches further may include a fourth electrically controllable switch connected between the neutral AC connection and the fourth switch pair common node. The plurality of electrically controllable switches further may include a fifth electrically controllable switch connected between the first switch pair common node and the second switch pair common node. The plurality of electrically controllable switches further may include a sixth electrically controllable switch connected between the third switch pair common node and the fourth switch pair common node.

In another aspect of the present disclosure, the one or more switch pairs further may include a first switch pair connected between the first terminal of the first primary winding and the second terminal of the first primary winding and having a first switch pair common node in electrical communication with the first AC phase connection. The one or more switch pairs further may include a second switch pair connected between the first terminal of the first primary winding and the second terminal of the first primary winding and having a second switch pair common node in electrical communication with the neutral AC connection. The one or more switch pairs further may include a third switch pair connected between a first terminal of a second primary winding of the one or more primary windings of the one or more transformers and a second terminal of the second primary winding and having a third switch pair common node in electrical communication with the second AC phase connection. The one or more switch pairs further may include a fourth switch pair connected between the first terminal of the second primary winding and the second terminal of the second primary winding and having a fourth switch pair common node in electrical communication with the neutral AC connection. The one or more switch pairs further may include a fifth switch pair connected between a first terminal of a third primary winding of the one or more primary windings of the one or more transformers and a second terminal of the third primary winding and having a fifth switch pair common node in electrical communication with the third AC phase connection. The one or more switch pairs further may include a sixth switch pair connected between the first terminal of the third primary winding and the second terminal of the third primary winding and having a sixth switch pair common node in electrical communication with the neutral AC connection.

In another aspect of the present disclosure, the plurality of electrically controllable switches further may include a first electrically controllable switch connected between the first AC phase connection and the first switch pair common node. The plurality of electrically controllable switches further may include a second electrically controllable switch connected between the second AC phase connection and the third switch pair common node. The plurality of electrically controllable switches further may include a third electrically controllable switch connected between the third AC phase connection and the fifth switch pair common node. The plurality of electrically controllable switches further may include a fourth electrically controllable switch connected between the first switch pair common node and the third switch pair common node. The plurality of electrically controllable switches further may include a fifth electrically controllable switch connected between the first switch pair common node and the fifth switch pair common node. The plurality of electrically controllable switches further may include a sixth electrically controllable switch connected between the neutral AC connection and the second switch pair common node, the fourth switch pair common node, and the sixth switch pair common node.

In another aspect of the present disclosure, the one or more secondary AC to DC converters further may include one or more active full wave rectifiers. An AC side of each of the one or more active full wave rectifiers is connected to one or more secondary windings of the one or more transformers. A DC side of each of the one or more active full wave rectifiers is connected in parallel to one or more DC load connections of the one or more load connection ports.

In another aspect of the present disclosure, the secondary side further may include one or more AC to AC converters. A first side of each of the one or more AC to AC converters is connected to one or more secondary windings of the one or more transformers. A second side of each of the one or more AC to AC converters is connected to one or more AC load connections of the one or more load connection ports.

In another aspect of the present disclosure, the one or more AC to AC converters further may include one or more switch pairs. A first switch of each of the one or more switch pairs is connected between a first terminal of the one or more AC load connections and a switch pair common node. A second switch of each of the one or more switch pairs is connected between a second terminal of the one or more AC load connections and the switch pair common node. The switch pair common node is in electrical communication with the one or more secondary windings of the one or more transformers.

According to several aspects, a power converter for a vehicle is provided. The power converter may include a primary side having a line connection port and one or more primary alternating current (AC) to AC converters. The line connection port further may include a first AC phase connection, a second AC phase connection, a third AC phase connection, a neutral AC connection, and a plurality of electrically controllable switches in electrical communication with the first AC phase connection, the second AC phase connection, the third AC phase connection, and the neutral AC connection. The power converter further may include a secondary side having one or more secondary alternating current (AC) to direct current (DC) converters and one or more load connection ports. At least one of the one or more load connection ports in electrical communication with a battery of the vehicle. The power converter further may include a transformer configured to transfer power between the primary side and the secondary side.

In another aspect of the present disclosure, the one or more primary AC to AC converters further may include a single primary AC to AC converter having four single converter line ports and two single converter load ports. A first of the four single converter line ports is connected to the first AC phase connection. A second of the four single converter line ports is connected to the second AC phase connection. A third of the four single converter line ports is connected to the third AC phase connection. A fourth of the four single converter line ports is connected to the neutral AC connection. The two single converter load ports are connected to one or more primary windings of the transformer.

In another aspect of the present disclosure, the first of the four single converter line ports is connected to the first AC phase connection via a first of the plurality of electrically controllable switches. The second of the four single converter line ports is connected to the second AC phase connection via a second of the plurality of electrically controllable switches. The third of the four single converter line ports is connected to the third AC phase connection via a third of the plurality of electrically controllable switches. The fourth of the four single converter line ports is connected to the neutral AC connection via a fourth of the plurality of electrically controllable switches. A fifth of the plurality of electrically controllable switches is connected between the first of the four single converter line ports and the second of the four single converter line ports. A sixth of the plurality of electrically controllable switches is connected between the third of the four single converter line ports and the fourth of the four single converter line ports.

In another aspect of the present disclosure, the one or more primary AC to AC converters further may include a first primary AC to AC converter having two first converter line ports and two first converter load ports. A first of the two first converter line ports is connected to the first AC phase connection. A second of the two first converter line ports is connected to the neutral AC connection. The two first converter load ports are connected to one or more primary windings of the transformer. A second primary AC to AC converter having two second converter line ports and two second converter load ports. A first of the two second converter line ports is connected to the second AC phase connection. A second of the two second converter line ports is connected to the neutral AC connection. The two second converter load ports are connected to the one or more primary windings of the transformer. A third primary AC to AC converter having two third converter line ports and two third converter load ports. A first of the two third converter line ports is connected to the third AC phase connection. A second of the two third converter line ports is connected to the neutral AC connection. The two third converter load ports are connected to the one or more primary windings of the transformer.

In another aspect of the present disclosure, the first of the four single converter line ports is connected to the first AC phase connection via a first of the plurality of electrically controllable switches. The second of the four single converter line ports is connected to the second AC phase connection via a second of the plurality of electrically controllable switches. The third of the four single converter line ports is connected to the third AC phase connection via a third of the plurality of electrically controllable switches. The fourth of the four single converter line ports is connected to the neutral AC connection via a fourth of the plurality of electrically controllable switches. A fifth of the plurality of electrically controllable switches is connected between the first of the four single converter line ports and the second of the four single converter line ports. A sixth of the plurality of electrically controllable switches is connected between the third of the four single converter line ports and the fourth of the four single converter line ports.

In another aspect of the present disclosure, the one or more AC to DC converters further may include one or more rectifiers. An AC side of each of the one or more rectifiers is connected to one or more secondary windings of the transformer. A DC side of each of the one or more rectifiers is connected to one or more DC load connections of the one or more load connection ports.

In another aspect of the present disclosure, the secondary side further may include one or more AC to AC converters. A first side of each of the one or more AC to AC converters is connected to the one or more secondary windings of the transformer. A second side of each of the one or more AC to AC converters is connected to one or more AC load connections of the one or more load connection ports. The one or more AC load connections are in electrical communication with one or more external AC loads or sources.

According to several aspects, an on-board charging module (OBCM) for a vehicle is provided. The OBCM may include a primary side having a line connection port and a plurality of bi-directional semiconductor switches. The line connection port further may include a first AC phase connection, a second AC phase connection, a third AC phase connection, a neutral AC connection, and a plurality of electrically controllable switches in electrical communication with the first AC phase connection, the second AC phase connection, the third AC phase connection, and the neutral AC connection. The plurality of bi-directional semiconductor switches includes one or more bi-directional switch pairs. The one or more bi-directional switch pairs further may include a first bi-directional switch pair having a first switch pair common node in electrical communication with the first AC phase connection. The one or more bi-directional switch pairs further may include a second bi-directional switch pair having a second switch pair common node in electrical communication with the second AC phase connection. The one or more bi-directional switch pairs further may include a third bi-directional switch pair having a third switch pair common node in electrical communication with the third AC phase connection. The one or more bi-directional switch pairs further may include a fourth bi-directional switch pair having a fourth switch pair common node in electrical communication with the neutral AC connection. The OBCM further may include a secondary side having one or more alternating current (AC) to direct current (DC) converters, one or more AC to AC converters, and one or more load connection ports. At least one of the one or more load connection ports in electrical communication with a battery of the vehicle. At least one of the one or more load connection ports is configured to provide a high-voltage DC output. At least one of the one or more load connection ports is configured to provide a low-voltage DC output. At least one of the one or more load connection ports is configured to provide one or more AC outputs. The OBCM further may include a transformer configured to transfer power between the primary side and the secondary side. The transformer may include one or more magnetic cores, one or more primary windings, and one or more secondary windings. One of the one or more primary windings is in electrical communication with each of the one or more bi-directional switch pairs.

In another aspect of the present disclosure, the plurality of electrically controllable switches further may include a first electrically controllable switch connected between the first AC phase connection and the first switch pair common node. The plurality of electrically controllable switches further may include a second electrically controllable switch connected between the second AC phase connection and the second switch pair common node. The plurality of electrically controllable switches further may include a third electrically controllable switch connected between the third AC phase connection and the third switch pair common node. The plurality of electrically controllable switches further may include a fourth electrically controllable switch connected between the neutral AC connection and the fourth switch pair common node. The plurality of electrically controllable switches further may include a fifth electrically controllable switch connected between the first switch pair common node and the second switch pair common node. The plurality of electrically controllable switches further may include a sixth electrically controllable switch connected between the third switch pair common node and the fourth switch pair common node.

In another aspect of the present disclosure, the OBCM further may include a controller in electrical communication with each of the plurality of electrically controllable switches. To configure the OBCM for single phase line connection, the controller is programmed to close the first electrically controllable switch, open the second electrically controllable switch, open the third electrically controllable switch, close the fourth electrically controllable switch, close the fifth electrically controllable switch, and close the sixth electrically controllable switch. To configure the OBCM for three phase line connection, the controller is further programmed to close the first electrically controllable switch, close the second electrically controllable switch, close the third electrically controllable switch, close the fourth electrically controllable switch, open the fifth electrically controllable switch, and open the sixth electrically controllable switch.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a power converter, according to an exemplary embodiment;

FIG. 2 is a schematic diagram of a first exemplary embodiment of a primary side of the power converter of FIG. 1;

FIG. 3 is a schematic diagram of a second exemplary embodiment of the primary side of the power converter of FIG. 1;

FIG. 4 is a schematic diagram of a third exemplary embodiment of the primary side of the power converter of FIG. 1;

FIG. 5A is a schematic diagram of an exemplary embodiment of a secondary side of the power converter of FIG. 1, according to an exemplary embodiment;

FIG. 5B is a continuation of the schematic diagram of FIG. 5A, according to an exemplary embodiment; and

FIG. 6 is a schematic diagram of an exemplary implementation of the power converter, according to an exemplary embodiment.

### DETAILED DESCRIPTION

The following description is merely exemplary in nature and is not intended to limit the present disclosure, application, or uses.

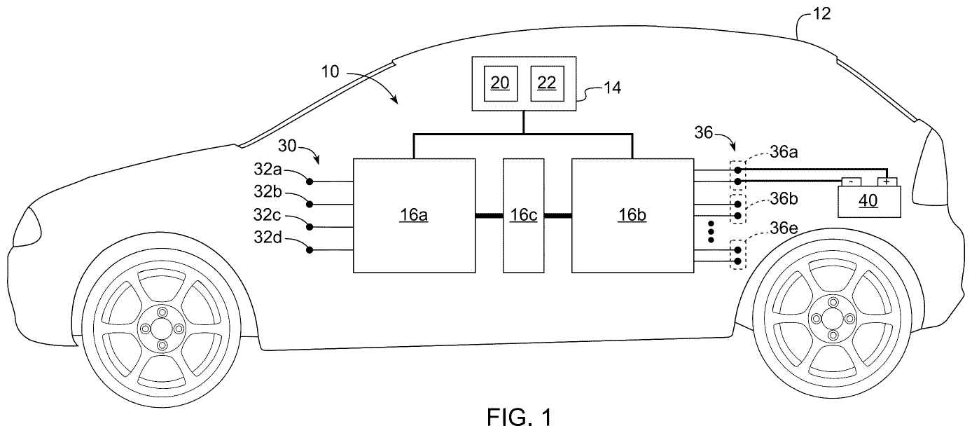

Referring to FIG. 1, a power converter is illustrated and generally indicated by reference number 10. In the present disclosure, the power converter 10 is discussed in the context of a vehicle application, and more particularly, an electric vehicle charging application, and more particularly, three functions: electric vehicle charging, vehicle to load (V2L) functionality, and auxiliary load power support. In the present disclosure, the power converter 10 is also referred to as an on-board charging module (OBCM) or integrated power electronics. Accordingly, the power converter 10 is shown with an exemplary vehicle 12. While a passenger vehicle is illustrated, it should be appreciated that the vehicle 12 may be any type of vehicle without departing from the scope of the present disclosure. It should also be understood that the present disclosure is also applicable to power converters having various other applications and uses. The power converter 10 generally includes a controller 14, a primary side 16a, a secondary side 16b, and a transformer 16c.

The controller 14 is used to control the power converter 10, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions. In an exemplary embodiment, the controller 14 controls the operation of the primary side 16a and the secondary side 16b as will be discussed in greater detail below.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions. The controller 14 may also include multiple controllers which are in electrical communication with each other.

The controller 14 is in electrical communication with the primary side 16a and the secondary side 16b. In an exemplary embodiment, the electrical communication is established using, for example, a CAN network, a FLEXRAY network, a local area network (e.g., WiFi, ethernet, and the like), a serial peripheral interface (SPI) network, direct analog communication, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

Various exemplary embodiments of the primary side 16a will be discussed in detail below. In general, the primary side 16a includes at least a line connection port 30 and one or more primary alternating current (AC) to AC converters.

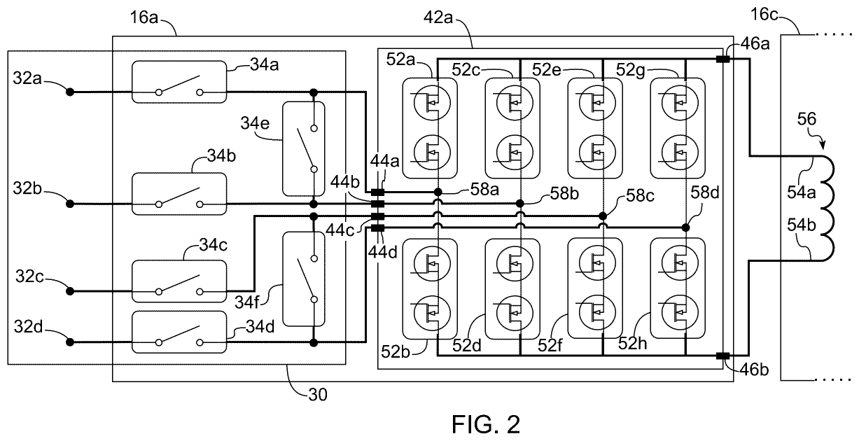

The line connection port 30 includes a first alternating current (AC) phase connection 32a, a second AC phase connection 32b, a third AC phase connection 32c, a neutral AC connection 32d, and a plurality of electrically controllable switches (FIGS. 2-4). The line connection port 30 allows for single phase or three phase connection to an AC power source such as, for example, electric vehicle supply equipment (EVSE). Furthermore, the line connection port 30 allows the power converter 10 to act as a single phase or three phase AC power source, providing AC power to a single phase or three phase AC load. In some embodiments, the line connection port 30 may only include the first AC phase connection 32a and the neutral AC connection 32d and omit the plurality of electrically controllable switches to function in a single phase mode.

The plurality of electrically controllable switches are used to control connections between the first AC phase connection 32a, the second AC phase connection 32b, the third AC phase connection 32c, and the neutral AC connection 32d and the rest of the primary side 16a to switch the line connection port 30 between single phase and three phase operation. In an exemplary embodiment, the plurality of electrically controllable switches includes a first electrically controllable switch 34a (FIGS. 2-4), a second electrically controllable switch 34b (FIGS. 2-4), a third electrically controllable switch 34c (FIGS. 2-4), a fourth electrically controllable switch 34d (FIGS. 2-4), a fifth electrically controllable switch 34e (FIGS. 2-4), and a sixth electrically controllable switch 34f (FIGS. 2-4). The plurality of electrically controllable switches are connected differently in the various embodiments of the primary side 16a, as will be shown and described below in reference to FIGS. 2-4. In an exemplary embodiment, the plurality of electrically controllable switches are realized using electromechanical relays, solid state relays, contactors, and/or the like. The plurality of electrically controllable switches are in electrical communication with the controller 14.

Various exemplary embodiments of the secondary side 16b will be discussed in detail below. In general, the secondary side 16b includes one or more load connection ports 36, one or more AC to direct current (DC) converters, and one or more AC to AC converters.

The one or more load connection ports 36 include at least a first DC load connection 36a in electrical communication with a battery 40 of the vehicle 12. The one or more load connection ports 36 allow the power converter 10 to provide/receive power to/from one or more DC loads, including, for example, the battery 40, one or more DC power systems of the vehicle 12, one or more auxiliary vehicle loads (e.g., twelve volt or forty-eight volt loads), and/or the like. The one or more AC to DC converters are used to convert power to provide/receive power to/from the one or more DC loads, as will be discussed in greater detail below. The one or more AC to AC converters are used to convert power to provide/receive power to/from the one or more AC loads, as will be discussed in greater detail below.

It should be understood that any of the various exemplary embodiments of the primary side 16a may be combined with any of the various exemplary embodiments of the secondary side 16b to form the power converter 10. It should also be understood that the power converter 10 is operable to transfer power bi-directionally, including from the line connection port 30 to the one or more load connection ports 36 or from the one or more load connection ports 36 to the line connection port 30.

The transformer 16c is used to transfer power between the primary side 16a and the secondary side 16b. In an exemplary embodiment, the transformer 16c includes one or more primary windings and one or more secondary windings electromagnetically coupled through a magnetic core. It should be understood that any type of transformer, including, for example, a transformer with a single primary winding and a single secondary winding, a transformer with multiple primary windings and a single secondary winding, a transformer with a single primary winding and multiple secondary windings, or a transformer with multiple primary windings and multiple secondary windings is within the scope of the present disclosure.

In other words, it should be understood that the transformer 16c may include any number of primary windings coupled with any number of secondary windings without departing from the scope of the present disclosure. Furthermore, the transformer 16c may also be realized using multiple separate transformers or a transformer having multiple magnetic cores which may or may not be magnetically coupled. It should be understood that winding ratios and winding numbers of each of the primary windings and each of the secondary windings may be determined based on desired input/output voltages, operating frequency, and/or the like. One of ordinary skill in the art will understand how to select an appropriate transformer based on the primary side 16a and the secondary side 16b used to construct the power converter 10.

Referring to FIG. 2, a schematic diagram of a first exemplary embodiment of the primary side 16a is shown. In general, the first exemplary embodiment of the primary side 16a includes a single primary AC to AC converter 42a having four single converter line ports (i.e., a first single converter line port 44a, a second single converter line port 44b, a third single converter line port 44c, and a fourth single converter line port 44d) and two single converter load ports (i.e., a first single converter load port 46a and a second single converter load port 46b).

The first single converter line port 44a is connected to the first AC phase connection 32a via the first electrically controllable switch 34a. The second single converter line port 44b is connected to the second AC phase connection 32b via the second electrically controllable switch 34b. The third single converter line port 44c is connected to the third AC phase connection 32c via the third electrically controllable switch 34c. The fourth single converter line port 44d is connected to the neutral AC connection 32d via the fourth electrically controllable switch 34d. The fifth electrically controllable switch 34e is connected between the first single converter line port 44a and the second single converter line port 44b. The sixth electrically controllable switch 34f is connected between the third single converter line port 44c and the fourth single converter line port 44d. The first single converter load port 46a and the second single converter load port 46b are connected to a first primary winding 56 of the transformer 16c.

In an exemplary embodiment, the first exemplary embodiment of the primary side 16a includes one or more switch pairs which form an alternating current (AC) to AC converter for single or three phase AC line inputs. In a non-limiting example, the one or more switch pairs include uni-directional semiconductor switches. In another non-limiting example, the one or more switch pairs include bi-directional semiconductor switches forming a bi-directional switch pair. In the scope of the present disclosure, a bi-directional semiconductor switch is a device which can conduct current in both directions when on, block voltage in both polarities when off, and can be turned on/off using a control signal. Bi-directional semiconductor switches may be implemented in various manners, including, for example, using a triac, two anti-parallel thyristors, two anti-parallel or anti-series insulated gate bipolar transistors (IGBTs), two anti-parallel or anti-series metal oxide field effect transistors (MOSFETs), and/or the like.

For the sake of example, in the present disclosure, the bi-directional semiconductor switches are shown as anti-series MOSFETs. It should be understood that any suitable component or combination of components may be used to implement the bi-directional semiconductor switches without departing from the scope of the present disclosure. Furthermore, any suitable semiconductor material such as, for example silicon carbide (SiC), gallium nitride (GaN), and/or the like may be used to implement the bi-directional semiconductor switches without departing from the scope of the present disclosure.

In the scope of the present disclosure, a bi-directional switch pair includes two bi-directional semiconductor switches connected in a series configuration. A common node between the two bi-directional semiconductor switches is referred to as a switch pair common node.

In the first exemplary embodiment of the primary side 16a, the one or more bi-directional switch pairs includes a first bi-directional switch pair, a second bi-directional switch pair, a third bi-directional switch pair, and a fourth bi-directional switch pair. The first bi-directional switch pair has a first bi-directional switch 52a connected between a first terminal 54a of the first primary winding 56 of one or more primary windings of the transformer 16c and a first switch pair common node 58a and a second bi-directional switch 52b connected between a second terminal 54b of the first primary winding 56 and the first switch pair common node 58a as shown in FIG. 2. In an exemplary embodiment, the third bi-directional switch 52c, the fourth bi-directional switch 52d, the fifth bi-directional switch 52e, the eighth bi-directional switch 52h, the first electrically controllable switch 34a, the second electrically controllable switch 34b, the fifth electrically controllable switch 34e, and the sixth electrically controllable switch 34f may be omitted if only single-phase operation is desired.

The second bi-directional switch pair has a third bi-directional switch 52c connected between the first terminal 54a and a second switch pair common node 58b and a fourth bi-directional switch 52d connected between the second terminal 54b and the second switch pair common node 58b as shown in FIG. 2. The third bi-directional switch pair has a fifth bi-directional switch 52e connected between the first terminal 54a and a third switch pair common node 58c and a sixth bi-directional switch 52f connected between the second terminal 54b and the third switch pair common node 58c as shown in FIG. 2. The fourth bi-directional switch pair has a seventh bi-directional switch 52g connected between the first terminal 54a and a fourth switch pair common node 58d and an eighth bi-directional switch 52h connected between the second terminal 54b and the fourth switch pair common node 58d as shown in FIG. 2.

In the first exemplary embodiment of the primary side 16a, the first switch pair common node 58a is in electrical communication with the first AC phase connection 32a via the first electrically controllable switch 34a as shown in FIG. 2. The second switch pair common node 58b is in electrical communication with the second AC phase connection 32b via the second electrically controllable switch 34b as shown in FIG. 2. The third switch pair common node 58c is in electrical communication with the third AC phase connection 32c via the third electrically controllable switch 34c as shown in FIG. 2. The fourth switch pair common node 58d is in electrical communication with the neutral AC connection 32d via the fourth electrically controllable switch 34d as shown in FIG. 2. The fifth electrically controllable switch 34e is connected between the first switch pair common node 58a and the second switch pair common node 58b as shown in FIG. 2. The sixth electrically controllable switch 34f is connected between the third switch pair common node 58c and the fourth switch pair common node 58d as shown in FIG. 2.

In an exemplary embodiment, the controller 14 is programmed to control the operation of the bi-directional switch pairs using control terminals (e.g., gate terminals) of the bi-directional switch pairs to provide AC to AC power conversion from the line connection port 30 to the first primary winding 56 or from the first primary winding 56 to the line connection port 30. In a non-limiting example, the controller 14 controls the operation of the bi-directional switch pairs using an interleaved control methodology, a dual active bridge (DAB) control methodology, a capacitor-inductor-inductor-capacitor (CLLC) control methodology, a zero-voltage switching (ZVS) control methodology, and/or the like. In a non-limiting example, the controller 14 controls the operation of the bi-directional switch pairs to provide additional capabilities such as, for example, power factor control (PFC).

In an exemplary embodiment, the controller 14 is programmed to control the operation of the plurality of electrically controllable switches to configure the primary side 16a for one or three phase operation (i.e., for one or three phase line connection). Table-1 indicates an exemplary control method for the plurality of electrically controllable switches for the first exemplary embodiment of the primary side 16a:

TABLE 1

| | switch | | | | | |
|---|---|---|---|---|---|---|
| mode | S1 | S2 | S3 | S4 | S5 | S6 |
| Single phase | Closed | Open | Open | Closed | Closed | Closed |
| Three phase | Closed | Closed | Closed | Closed | Open | Open |

where S1 is the first electrically controllable switch 34a, S2 is the second electrically controllable switch 34b, S3 is the third electrically controllable switch 34c, S4 is the fourth electrically controllable switch 34d, S5 is the fifth electrically controllable switch 34e, S6 is the sixth electrically controllable switch 34f, “closed” means that the switch conducts current, and “open” means that the switch blocks current.

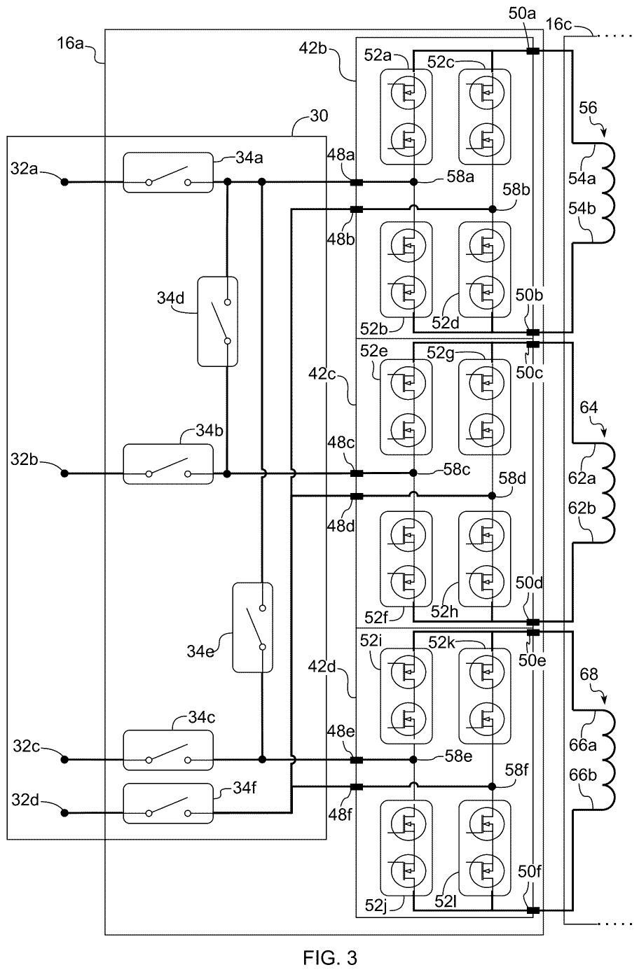

Referring to FIG. 3, a schematic diagram of a second exemplary embodiment of the primary side 16a is shown. In general, the second exemplary embodiment of the primary side 16a includes a first primary AC to AC converter 42b, a second primary AC to AC converter 42c, and a third primary AC to AC converter 42d. The first primary AC to AC converter 42b has two first converter line ports (i.e., a first first converter line port 48a and a second first converter line port 48b) and two first converter load ports (i.e., a first first converter load port 50a and a second first converter load port 50b). The second primary AC to AC converter 42c has two second converter line ports (i.e., a first second converter line port 48c and a second second converter line port 48d) and two second converter load ports (i.e., a first second converter load port 50c and a second second converter load port 50d). The third primary AC to AC converter 42d has two third converter line ports (i.e., a first third converter line port 48e and a second third converter line port 48f) and two third converter load ports (i.e., a first third converter load port 50e and a second third converter load port 50f).

The first first converter line port 48a is connected to the first AC phase connection 32a via the first electrically controllable switch 34a. The first second converter line port 48c is connected to the second AC phase connection 32b via the second electrically controllable switch 34b. The first third converter line port 48e is connected to the third AC phase connection 32c via the third electrically controllable switch 34c. The second first converter line port 48b, the second second converter line port 48d, and the second third converter line port 48f are connected to the AC neutral connection 32d via the fifth electrically controllable switch 34f. The fourth electrically controllable switch 34d is connected between the first first converter line port 48a and the first second converter line port 48c. The sixth electrically controllable switch 34e is connected between the first first converter line port 48a and the first third converter line port 48e. The first first converter load port 50a and the second first converter load port 50b are connected to the first primary winding 56 of the transformer 16c. The first second converter load port 50c and the second second converter load port 50d are connected to a second primary winding 64 of the transformer 16c. The first third converter load port 50e and the second third converter load port 50f are connected to a third primary winding 68 of the transformer 16c.

In an exemplary embodiment, the second exemplary embodiment of the primary side 16a includes one or more switch pairs which form a plurality of AC to AC converters for single or three phase AC line inputs. In a non-limiting example, the one or more switch pairs include uni-directional semiconductor switches. In another non-limiting example, the one or more switch pairs include bi-directional semiconductor switches forming one or more bi-directional switch pairs. In the second exemplary embodiment of the primary side 16a, the one or more bi-directional switch pairs includes the first bi-directional switch pair, the second bi-directional switch pair, the third bi-directional switch pair, the fourth bi-directional switch pair, a fifth bi-directional switch pair, and a sixth bi-directional switch pair. In the second exemplary embodiment of the primary side 16a, the first bi-directional switch 52a is connected between the first terminal 54a of the first primary winding 56 of the one or more primary windings of the transformer 16c and the first switch pair common node 58a and the second bi-directional switch 52b is connected between the second terminal 54b of the first primary winding 56 and the first switch pair common node 58a as shown in FIG. 3.

In the second exemplary embodiment of the primary side 16a, the third bi-directional switch 52c is connected between the first terminal 54a and the second switch pair common node 58b and the fourth bi-directional switch 52d is connected between the second terminal 54b and the second switch pair common node 58b as shown in FIG. 3. In the second exemplary embodiment of the primary side 16a, the fifth bi-directional switch 52e is connected between a first terminal 62a of the second primary winding 64 of the one or more primary windings of the transformer 16c and a third switch pair common node 58c and the sixth bi-directional switch 52f is connected between a second terminal 62b of the second primary winding 64 and the third switch pair common node 58c as shown in FIG. 3. In the second exemplary embodiment of the primary side 16a, the seventh bi-directional switch 52g is connected between the first terminal 62a and the fourth switch pair common node 58d and the eighth bi-directional switch 52h is connected between the second terminal 62b and the fourth switch pair common node 58d as shown in FIG. 3.

In the second exemplary embodiment of the primary side 16a, the fifth bi-directional switch pair includes a ninth bi-directional switch 52i connected between a first terminal 66a of a third primary winding 68 of the one or more primary windings of the transformer 16c and a fifth switch pair common node 58e and an tenth bi-directional switch 52j connected between a second terminal 66b of the third primary winding 68 and the fifth switch pair common node 58e as shown in FIG. 3. In the second exemplary embodiment of the primary side 16a, the sixth bi-directional switch pair includes an eleventh bi-directional switch 52k connected between the first terminal 66a and a sixth switch pair common node 58f and a twelfth bi-directional switch 52l connected between the second terminal 66b and the sixth switch pair common node 58f as shown in FIG. 3.

In the second exemplary embodiment of the primary side 16a, the first switch pair common node 58a is in electrical communication with the first AC phase connection 32a via the first electrically controllable switch 34a as shown in FIG. 3. The third switch pair common node 58c is in electrical communication with the second AC phase connection 32b via the second electrically controllable switch 34b as shown in FIG. 3. The fifth switch pair common node 58e is in electrical communication with the third AC phase connection 32c via the third electrically controllable switch 34c as shown in FIG. 3. The second switch pair common node 58b, the fourth switch pair common node 58d, and the sixth switch pair common node 58f are in electrical communication with the neutral AC connection 32d via the sixth electrically controllable switch 34f as shown in FIG. 3. The fourth electrically controllable switch 34d is connected between the first switch pair common node 58a and the third switch pair common node 58c as shown in FIG. 3. The fifth electrically controllable switch 34e is connected between the first switch pair common node 58a and the fifth switch pair common node 58e as shown in FIG. 3. In an exemplary embodiment, one or more of the plurality of electrically controllable switches may be omitted if only single-phase operation is desired.

In an exemplary embodiment, the controller 14 is programmed to control the operation of the bi-directional switch pairs using control terminals (e.g., gate terminals) of the bi-directional switch pairs to provide AC to AC power conversion from the line connection port 30 to the first primary winding 56, the second primary winding 64, and the third primary winding 68 or from the first primary winding 56, the second primary winding 64, and the third primary winding 68 to the line connection port 30. In a non-limiting example, the controller 14 controls the operation of the bi-directional switch pairs using an interleaved control methodology, a dual active bridge (DAB) control methodology, a capacitor-inductor-inductor-capacitor (CLLC) control methodology, a zero-voltage switching (ZVS) control methodology, and/or the like. In a non-limiting example, the controller 14 controls the operation of the bi-directional switch pairs to provide additional capabilities such as, for example, power factor control (PFC).

In an exemplary embodiment, the controller 14 is programmed to control the operation of the plurality of electrically controllable switches to configure the primary side 16a for one or three phase operation (i.e., for one or three phase line connection). Table-2 indicates an exemplary control method for the plurality of electrically controllable switches for the second exemplary embodiment of the primary side 16a:

TABLE 2

| | switch | | | | | |
|---|---|---|---|---|---|---|
| mode | S1 | S2 | S3 | S4 | S5 | S6 |
| Single phase | Closed | Open | Open | Closed | Closed | Closed |
| Three phase | Closed | Closed | Closed | Open | Open | Closed |

where S1 is the first electrically controllable switch 34a, S2 is the second electrically controllable switch 34b, S3 is the third electrically controllable switch 34c, S4 is the fourth electrically controllable switch 34d, S5 is the fifth electrically controllable switch 34e, S6 is the sixth electrically controllable switch 34f, “closed” means that the switch conducts current, and “open” means that the switch blocks current.

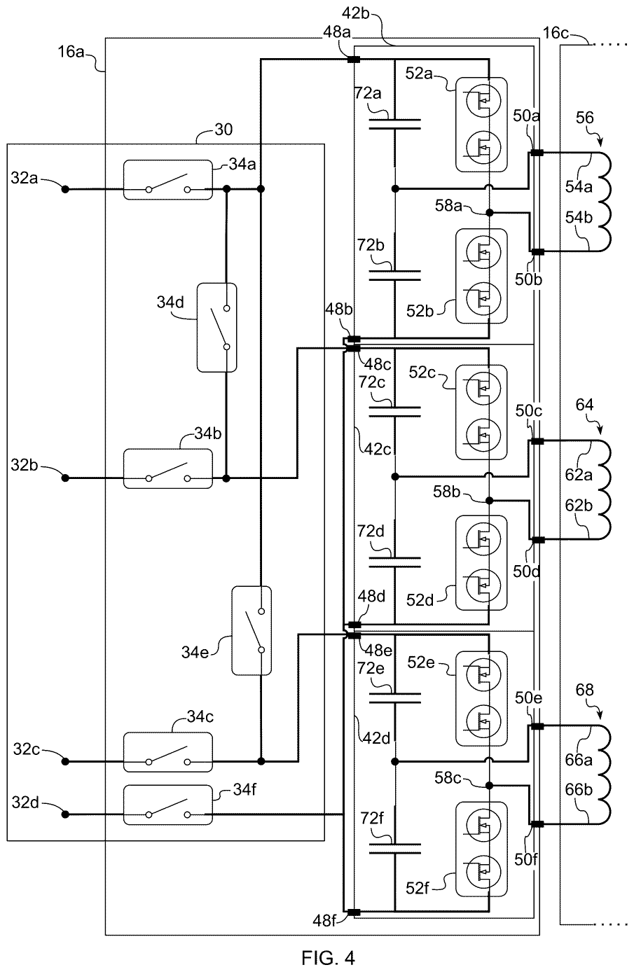

Referring to FIG. 4, a schematic diagram of a third exemplary embodiment of the primary side 16a is shown. In general, the third exemplary embodiment of the primary side 16a includes the first primary AC to AC converter 42b, the second primary AC to AC converter 42c, and the third primary AC to AC converter 42d. The first primary AC to AC converter 42b has two first converter line ports and two first converter load ports connected as discussed above in reference to FIG. 3. The second primary AC to AC converter 42c has two second converter line ports and two second converter load ports connected as discussed above in reference to FIG. 3. The third primary AC to AC converter 42d has two third converter line ports and two third converter load ports connected as discussed above in reference to FIG. 3.

In an exemplary embodiment, the third exemplary embodiment of the primary side 16a includes one or more switch pairs which form a plurality of AC to AC converters for single or three phase AC line inputs. In a non-limiting example, the one or more switch pairs include uni-directional semiconductor switches. In another non-limiting example, the one or more switch pairs include bi-directional semiconductor switches forming one or more bi-directional switch pairs. In the third exemplary embodiment of the primary side 16a, the one or more bi-directional switch pairs includes the first bi-directional switch pair, the second bi-directional switch pair, and the third bi-directional switch pair.

In the third exemplary embodiment of the primary side 16a, the first bi-directional switch 52a is connected between the first AC phase connection 32a (via the first electrically controllable switch 34a) and the first switch pair common node 58a and the second bi-directional switch 52b is connected between the neutral AC connection 32d (via the sixth electrically controllable switch 34f) and the first switch pair common node 58a as shown in FIG. 4. The first terminal 54a of the first primary winding 56 is connected to the first bi-directional switch 52a via a first capacitor 72a and the second bi-directional switch 52b via a second capacitor 72b as shown in FIG. 4. The second terminal 54b of the first primary winding 56 is connected to the first switch pair common node 58a as shown in FIG. 4.

In the third exemplary embodiment of the primary side 16a, the third bi-directional switch 52c is connected between the second AC phase connection 32b (via the second electrically controllable switch 34b) and the second switch pair common node 58b. The fourth bi-directional switch 52d is connected between the neutral AC connection 32d (via the sixth electrically controllable switch 34f) and the second switch pair common node 58b as shown in FIG. 4. The first terminal 62a of the second primary winding 64 is connected to the third bi-directional switch 52c via a third capacitor 72c and the fourth bi-directional switch 52d via a fourth capacitor 72d as shown in FIG. 4. The second terminal 62b of the second primary winding 64 is connected to the second switch pair common node 58b as shown in FIG. 4.

In the third exemplary embodiment of the primary side 16a, the fifth bi-directional switch 52e is connected between the third AC phase connection 32c (via the third electrically controllable switch 34c) and the third switch pair common node 58c. The sixth bi-directional switch 52f is connected between the neutral AC connection 32d (via the sixth electrically controllable switch 34f) and the third switch pair common node 58c as shown in FIG. 4. The first terminal 66a of the third primary winding 68 is connected to the fifth bi-directional switch 52e via a fifth capacitor 72e and the sixth bi-directional switch 52f via a sixth capacitor 72f as shown in FIG. 4. The second terminal 66b of the third primary winding 68 is connected to the third switch pair common node 58c as shown in FIG. 4.

In the third exemplary embodiment of the primary side 16a, the first bi-directional switch 52a is in electrical communication with the third bi-directional switch 52c via the fourth electrically controllable switch 34d as shown in FIG. 4. The first bi-directional switch 52a is in electrical communication with the fifth bi-directional switch 52e via the fifth electrically controllable switch 34e as shown in FIG. 4. In an exemplary embodiment, one or more of the plurality of electrically controllable switches may be omitted if only single-phase operation is desired.

In an exemplary embodiment, the controller 14 is programmed to control the operation of the bi-directional switch pairs using control terminals (e.g., gate terminals) of the bi-directional switch pairs to provide AC to AC power conversion from the line connection port 30 to the first primary winding 56, the second primary winding 64, and the third primary winding 68 or from the first primary winding 56, the second primary winding 64, and the third primary winding 68 to the line connection port 30. In a non-limiting example, the controller 14 controls the operation of the bi-directional switch pairs using an interleaved control methodology, a dual active bridge (DAB) control methodology, a capacitor-inductor-inductor-capacitor (CLLC) control methodology, a zero-voltage switching (ZVS) control methodology, and/or the like. In a non-limiting example, the controller 14 controls the operation of the bi-directional switch pairs to provide additional capabilities such as, for example, power factor control (PFC).

In an exemplary embodiment, the controller 14 is programmed to control the operation of the plurality of electrically controllable switches to configure the primary side 16a for one or three phase operation (i.e., for one or three phase line connection). Table-3 indicates an exemplary control method for the plurality of electrically controllable switches for the third exemplary embodiment of the primary side 16a:

TABLE 3

| | switch | | | | | |
|---|---|---|---|---|---|---|
| mode | S1 | S2 | S3 | S4 | S5 | S6 |
| Single phase | Closed | Open | Open | Closed | Closed | Closed |
| Three phase | Closed | Closed | Closed | Open | Open | Closed |

where S1 is the first electrically controllable switch 34a, S2 is the second electrically controllable switch 34b, S3 is the third electrically controllable switch 34c, S4 is the fourth electrically controllable switch 34d, S5 is the fifth electrically controllable switch 34e, S6 is the sixth electrically controllable switch 34f, “closed” means that the switch conducts current, and “open” means that the switch blocks current.

It should be understood that the first, second, and third exemplary embodiments of the primary side 16a are merely exemplary in nature, and that the primary side 16a may include additional elements such as, for example, input filters (e.g., input filters with an integrated inductor), output filters, passive elements, feedback/control circuitry, and/or the like without departing from the scope of the present disclosure.

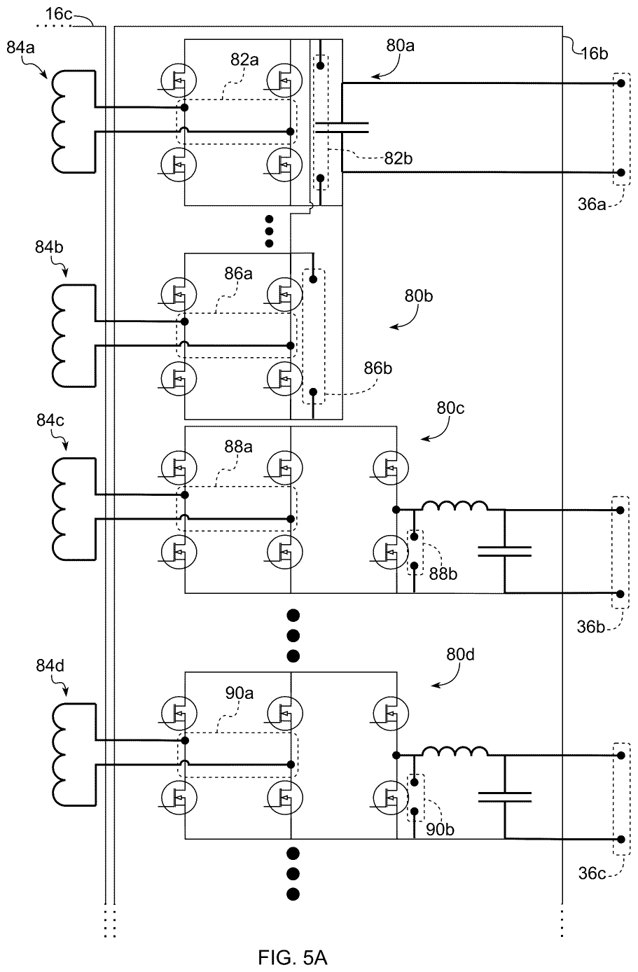

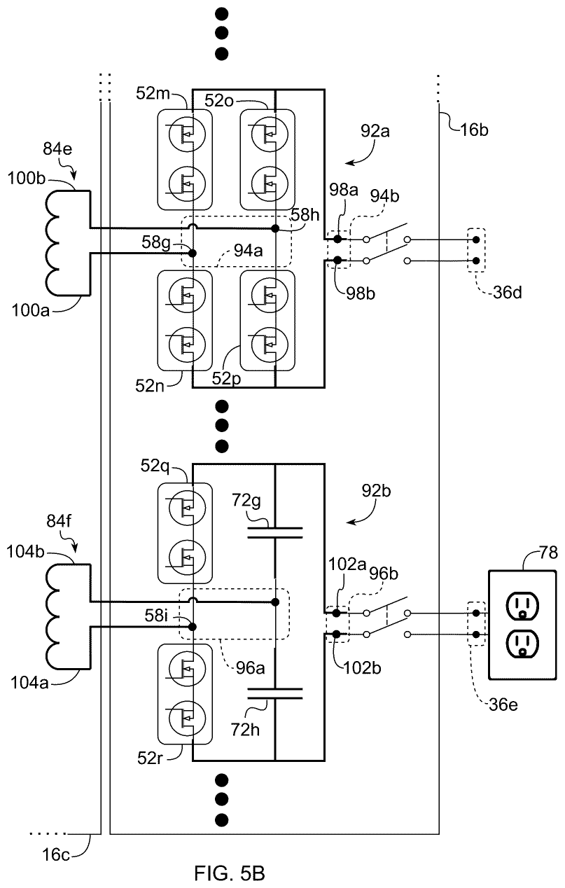

Referring to FIGS. 5A and 5B, a schematic diagram of an exemplary embodiment of the secondary side 16b is shown. FIG. 5B is a continuation of FIG. 5A. In an exemplary embodiment, the secondary side 16b includes at least one or more load connection ports 36 and one or more AC to direct current (DC) converters. In some embodiments, the secondary side 16b further includes one or more AC to AC converters.

The one or more load connection ports 36 are used to connect the secondary side 16b to one or more load devices, such as, for example, the battery 40 (FIG. 1). The one or more load connection ports 36 include at least one or more DC load connections, such as, for example, a first DC load connection 36a in electrical communication with the battery 40 of the vehicle 12. The one or more DC load connections allow the power converter 10 to provide/receive power to/from one or more DC loads, including, for example, the battery 40, one or more DC power systems of the vehicle 12, and/or the like. In a non-limiting example, the one or more load connection ports 36 further includes a second DC load connection 36b, a third DC load connection 36c, and/or any number of additional DC load connections. In a non-limiting example, at least one of the one or more load connection ports is configured to provide a high-voltage DC output (e.g., eight hundred volts), at least one of the one or more load connection ports is configured to provide a low-voltage DC output (e.g., twelve volts), and at least one of the one or more load connection ports is configured to provide an AC output.

In an exemplary embodiment, the DC load connections such as the second DC load connection 36b and the third DC load connection 36c are used to provide auxiliary power to other vehicle systems and/or other vehicle batteries. For example, the first DC load connection 36a may provide a higher voltage level (e.g., 400 volts) for charging the battery 40, while the second DC load connection 36b and the third DC load connection 36c may provide lower voltage levels (e.g., 48 volts, 12 volts, and/or the like) for powering other vehicle systems (e.g., ventilation systems, lighting systems, safety systems, and/or the like).

The one or more AC to DC converters are used to convert power to provide/receive power to/from the one or more DC load connections. In an exemplary embodiment, the one or more AC to DC converters includes one or more rectifiers. Each of the one or more rectifiers has an AC side connected to one or more secondary windings of the transformer 16c and a DC side connected to the one or more DC load connections of the one or more load connection ports 36. In a non-limiting example, a first rectifier 80a has a first AC side 82a connected to a first secondary winding 84a of the transformer 16c and a first DC side 82b connected to the first DC load connection 36a in parallel with a capacitor as shown in FIG. 5A. A second rectifier 80b has a second AC side 86a connected to a second secondary winding 84b of the transformer 16c and a second DC side 86b connected in parallel with the first DC side 82b to the first DC load connection 36a as shown in FIG. 5A. It should be understood that, as indicated by the ellipses in FIG. 5A, the one or more rectifiers may include any number of rectifiers connected in parallel to the first DC load connection 36a to provide additional power transfer capabilities to/from the first DC load connection 36a.

In a non-limiting example, a third rectifier 80c has a third AC side 88a connected to a third secondary winding 84c of the transformer 16c and a third DC side 88b connected to the second DC load connection 36b via one or more filtering components as shown in FIG. 5A. A fourth rectifier 80d has a fourth AC side 90a connected to a fourth secondary winding 84d of the transformer 16c and a fourth DC side 90b connected to the third DC load connection 36c via one or more filtering components as shown in FIG. 5A. It should be understood that, as indicated by the ellipses in FIG. 5A, the one or more rectifiers may include any number of rectifiers connected to any number of additional DC load connections to provide auxiliary power transfer capabilities to/from any number of additional DC load connections. It should further be understood that the one or more rectifiers may include additional input and/or output filters, including passive and/or active filters.

In an exemplary embodiment, the one or more rectifiers are full wave rectifiers including semiconductor devices (e.g., diodes) for converting AC to DC. In another exemplary embodiment, the one or more rectifiers are active full wave rectifiers including actively controllable semiconductor switches (e.g., MOSFETs) for converting AC to DC and controlling a DC output voltage, as shown in FIG. 5A. In a non-limiting example, the actively controllable semiconductor switches are controlled by the controller 14. It should be understood that the one or more rectifiers shown in FIG. 5A are merely exemplary in nature, and that additional and/or alternate types of rectifiers are also within the scope of the present disclosure.

Referring to FIG. 5B, in an exemplary embodiment, the one or more load connection ports 36 further includes one or more AC load connections and the secondary side 16b further includes one or more AC to AC converters.

In an exemplary embodiment, the one or more AC load connections includes, for example, a first AC load connection 36d (e.g., 120 volts/50 or 60 Hz AC, or the like), a second AC load connection 36e (240 volts/50 or 60 Hz, and/or the like), and/or any number of additional AC load connections (three phase 240V/50 or 60 Hz AC). The one or more AC load connections allow the power converter 10 to provide/receive power to/from one or more AC loads. In a non-limiting example, the one or more AC load connections allow the power converter 10 to provide/receive power to/from, for example, household devices, tools, appliances, electronic devices, and/or the like. In a non-limiting example, one or more of the AC load connections (e.g., the second AC load connection 36e) is in electrical communication with a vehicle to load (V2L) electrical outlet 78. It should be understood that the V2L electrical outlet 78 may be any type of outlet or connector and that the one or more AC load connections may be configured to provide various voltages and/or phase configurations (e.g., single phase, split phase, two phase, three phase, etc.) of AC output without departing from the scope of the present disclosure.

The one or more AC to AC converters are used to convert power to provide/receive power to/from the one or more AC load connections. In an exemplary embodiment, each of the one or more AC to AC converters has a first side connected to the one or more secondary windings of the transformer 16c and a second side connected to the one or more AC load connections of the one or more load connection ports 36. In a non-limiting example, a first AC to AC converter 92a has a first side 94a connected to a fifth secondary winding 84e of the transformer 16c and a second side 94b connected to the first AC load connection 36d via an electrically controllable switch (e.g., a relay) as shown in FIG. 5B. In a non-limiting example, a second AC to AC converter 92b has a first side 96a connected to a sixth secondary winding 84f of the transformer 16c and a second side 96b connected to the second AC load connection 36e via an electrically controllable switch (e.g., a relay) as shown in FIG. 5B.

In an exemplary embodiment, one or more of the one or more AC to AC converters includes one or more switch pairs. In a non-limiting example, the one or more switch pairs include uni-directional semiconductor switches. In another non-limiting example, the one or more switch pairs include bi-directional semiconductor switches forming one or more bi-directional switch pairs. In a non-limiting example, the first AC to AC converter 92a includes a seventh bi-directional switch pair and an eighth bi-directional switch pair. In the first AC to AC converter 92a, a thirteenth bi-directional switch 52m is connected between a first terminal 98a of the second side 94b of the first AC to AC converter 92a and a seventh switch pair common node 58g and a fourteenth bi-directional switch 52n is connected between a second terminal 98b of the second side 94b of the first AC to AC converter 92a and the seventh switch pair common node 58g as shown in FIG. 5B.

A fifteenth bi-directional switch 52o is connected between the first terminal 98a of the second side 94b of the first AC to AC converter 92a and an eighth switch pair common node 58h and a sixteenth bi-directional switch 52p is connected between the second terminal 98b of the second side 94b of the first AC to AC converter 92a and the eighth switch pair common node 58h as shown in FIG. 5B. The seventh switch pair common node 58g is in electrical communication with a first terminal 100a of the fifth secondary winding 84e. The eighth switch pair common node 58h is in electrical communication with a second terminal 100b of the fifth secondary winding 84e.

In the second AC to AC converter 92b, a seventeenth bi-directional switch 52q is connected between a first terminal 102a of the second side 96b of the second AC to AC converter 92b and a ninth switch pair common node 58i and an eighteenth bi-directional switch 52r is connected between a second terminal 102b of the second side 96b of the second AC to AC converter 92b and the ninth switch pair common node 58i as shown in FIG. 5B.

The ninth switch pair common node 58i is in electrical communication with a first terminal 104a of the sixth secondary winding 84f. A second terminal 104b of the sixth secondary winding 84f is in electrical communication with the first terminal 102a of the second side 96b of the second AC to AC converter 92b via a seventh capacitor 72g and with the second terminal 102b of the second side 96b of the second AC to AC converter 92b via an eighth capacitor 72h as shown in FIG. 5B.

It should be understood that the one or more AC to AC converters shown in FIG. 5B (i.e., the first AC to AC converter 92a and the second AC to AC converter 92b) are merely exemplary in nature, and that additional and/or alternate types of AC to AC converters are also within the scope of the present disclosure. It should also be understood that, as indicated by the ellipses in FIG. 5B, the one or more AC to AC converters may include any number of AC to AC converters connected to any number of AC load connections to provide AC power transfer capabilities to/from any number of additional AC load connections. For example, multiple AC to AC converters may be used in tandem to provide two or three phase AC output. It should further be understood that the one or more AC to AC converters may include additional input and/or output filters, including passive and/or active filters.

It should be understood that the depiction of the secondary side 16b in FIGS. 5A and 5B is merely exemplary in nature, and that the secondary side 16b may include any quantity and/or type of AC to DC and/or AC to DC converters without departing from the scope of the present disclosure. Furthermore, it should be understood that, in an exemplary embodiment, any one or more of the various exemplary embodiments of the primary side 16a discussed above is electromagnetically coupled to the exemplary embodiment of the secondary side 16b discussed above via the transformer 16c, allowing for bi-directional power transfer between the primary side 16a and the secondary side 16b.

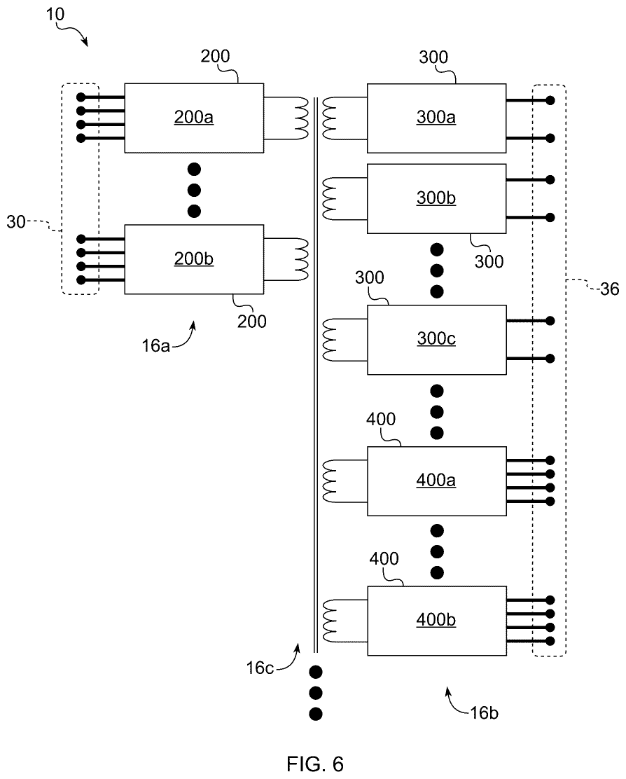

Referring to FIG. 6, a schematic diagram of an exemplary implementation of the power converter 10 is shown. In an exemplary embodiment, the primary side 16a includes one or more primary AC to AC converters 200 including, for example, a first primary AC to AC converter 200a and a second primary AC to AC converter 200b. It should be understood that the one or more primary AC to AC converters 200 may include any number of primary AC to AC converters 200 including only one primary AC to AC converter 200. It should be understood that the one or more primary AC to AC converters 200 may be realized according to any one or more of the exemplary embodiments discussed in reference to FIGS. 2, 3, and/or 4, and/or with additional or different circuits, including, for example, single-stage converters, multi-stage converters, and/or the like.

In an exemplary embodiment, the secondary side 16b includes one or more secondary AC to DC converters 300 and/or one or more secondary AC to AC converters 400. In a non-limiting example, the secondary side 16b includes a first secondary AC to DC converter 300a configured to transfer energy to/from the battery 40, a second secondary AC to DC converter 300b configured to transfer energy to/from twelve volt DC loads/sources, and a third secondary AC to DC converter 300c configured to transfer energy to/from forty-eight volt DC loads/sources. It should be understood that the one or more secondary AC to DC converters 300 may include any number of secondary AC to DC converters 300, including only one secondary AC to DC converter 300. Furthermore, the voltages discussed above are merely exemplary in nature, and additional/different voltages may be provided.

In a non-limiting example, the secondary side 16b further includes a first secondary AC to AC converter 400a configured to transfer energy to/from AC loads/sources (e.g., the V2L electrical outlet 78 and/or other V2L applications) and a second secondary AC to AC converter 400b configured to transfer energy to/from AC loads/sources (e.g., the V2L electrical outlet 78 and/or other V2L applications). It should be understood that the one or more secondary AC to AC converters 400 may include any number of secondary AC to AC converters 400, including only one secondary AC to AC converter 400. Furthermore, the one or more secondary AC to AC converters 400 may be configured to provide any voltage or phase output, including single phase, split phase, three phase, and/or the like. It should be understood that the one or more secondary AC to DC converters 300 and/or the one or more secondary AC to AC converters 400 may be realized using any one or more of the circuits discussed in reference to FIGS. 5A, and/or 5B, and/or with additional or different circuits including, for example, single-stage converters, multi-stage converters, and/or the like.

In a non-limiting example, the transformer 16c is realized as a multiple winding transformer with multiple primary windings and multiple secondary windings coupled through a common magnetic core. It should be understood that the transformer 16c may be realized with any winding and core configuration, as discussed in greater detail above.

The power converter 10 of the present disclosure offers several advantages. Using the power converter 10 for vehicle charging applications allows for reduced part-count, weight, and size for OBCMs. Additionally, the power converter 10 allows for simultaneous AC power input (e.g., via the line connection port 30) and AC power output (e.g., via the vehicle to load (V2L) electrical outlet 78). Furthermore, the power converter 10 may be operated at high frequencies, allowing for reduced capacitor and inductor size. Furthermore, the power converter 10 provides power factor control (PFC) capabilities and may include an input filter with an integrated inductor, reducing packaging size and harmonics noise.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A power converter, comprising:
a primary side having a line connection port and a plurality of semiconductor switches;
a secondary side having one or more alternating current (AC) to direct current (DC) converters and one or more load connection ports; and
one or more transformers configured to transfer power between the primary side and the secondary side.

2. The power converter of claim 1, the line connection port further comprising:
two or more of:
a first AC phase connection;
a second AC phase connection;
a third AC phase connection;
a neutral AC connection; and
a plurality of electrically controllable switches in electrical communication with the first AC phase connection, the second AC phase connection, the third AC phase connection, and the neutral AC connection.

3. The power converter of claim 2, the plurality of semiconductor switches further comprising:
one or more switch pairs, wherein a first switch of each of the one or more switch pairs is connected between a first terminal of a first primary winding of one or more primary windings of the one or more transformers and a switch pair common node, wherein a second switch of each of the one or more switch pairs is connected between a second terminal of the first primary winding of the one or more primary windings of the one or more transformers and the switch pair common node, and wherein the switch pair common node is in electrical communication with the line connection port.

4. The power converter of claim 3, the one or more switch pairs further comprising:
a first switch pair connected between the first terminal of the first primary winding and the second terminal of the first primary winding and having a first switch pair common node in electrical communication with the first AC phase connection;
a second switch pair connected between the first terminal of the first primary winding and the second terminal of the first primary winding and having a second switch pair common node in electrical communication with the second AC phase connection;
a third switch pair connected between the first terminal of the first primary winding and the second terminal of the first primary winding and having a third switch pair common node in electrical communication with the third AC phase connection; and
a fourth switch pair connected between the first terminal of the first primary winding and the second terminal of the first primary winding and having a fourth switch pair common node in electrical communication with the neutral AC connection.

5. The power converter of claim 4, the plurality of electrically controllable switches further comprising:
a first electrically controllable switch connected between the first AC phase connection and the first switch pair common node;
a second electrically controllable switch connected between the second AC phase connection and the second switch pair common node;
a third electrically controllable switch connected between the third AC phase connection and the third switch pair common node;
a fourth electrically controllable switch connected between the neutral AC connection and the fourth switch pair common node;
a fifth electrically controllable switch connected between the first switch pair common node and the second switch pair common node; and
a sixth electrically controllable switch connected between the third switch pair common node and the fourth switch pair common node.

6. The power converter of claim 3, the one or more switch pairs further comprising:
a first switch pair connected between the first terminal of the first primary winding and the second terminal of the first primary winding and having a first switch pair common node in electrical communication with the first AC phase connection;
a second switch pair connected between the first terminal of the first primary winding and the second terminal of the first primary winding and having a second switch pair common node in electrical communication with the neutral AC connection;
a third switch pair connected between a first terminal of a second primary winding of the one or more primary windings of the one or more transformers and a second terminal of the second primary winding and having a third switch pair common node in electrical communication with the second AC phase connection;
a fourth switch pair connected between the first terminal of the second primary winding and the second terminal of the second primary winding and having a fourth switch pair common node in electrical communication with the neutral AC connection;
a fifth switch pair connected between a first terminal of a third primary winding of the one or more primary windings of the one or more transformers and a second terminal of the third primary winding and having a fifth switch pair common node in electrical communication with the third AC phase connection; and
a sixth switch pair connected between the first terminal of the third primary winding and the second terminal of the third primary winding and having a sixth switch pair common node in electrical communication with the neutral AC connection.

7. The power converter of claim 6, the plurality of electrically controllable switches further comprising:
a first electrically controllable switch connected between the first AC phase connection and the first switch pair common node;
a second electrically controllable switch connected between the second AC phase connection and the third switch pair common node;
a third electrically controllable switch connected between the third AC phase connection and the fifth switch pair common node;
a fourth electrically controllable switch connected between the first switch pair common node and the third switch pair common node;
a fifth electrically controllable switch connected between the first switch pair common node and the fifth switch pair common node; and
a sixth electrically controllable switch connected between the neutral AC connection and the second switch pair common node, the fourth switch pair common node, and the sixth switch pair common node.

8. The power converter of claim 1, the one or more AC to DC converters further comprising:
one or more active full wave rectifiers, wherein an AC side of each of the one or more active full wave rectifiers is connected to one or more secondary windings of the one or more transformers, and wherein a DC side of each of the one or more active full wave rectifiers is connected in parallel to one or more DC load connections of the one or more load connection ports.

9. The power converter of claim 1, the secondary side further comprising:
one or more AC to AC converters, wherein a first side of each of the one or more AC to AC converters is connected to one or more secondary windings of the one or more transformers, and wherein a second side of each of the one or more AC to AC converters is connected to one or more AC load connections of the one or more load connection ports.

10. The power converter of claim 9, the one or more AC to AC converters further comprising:
one or more switch pairs, wherein a first switch of each of the one or more switch pairs is connected between a first terminal of the one or more AC load connections and a switch pair common node, wherein a second switch of each of the one or more switch pairs is connected between a second terminal of the one or more AC load connections and the switch pair common node, and wherein the switch pair common node is in electrical communication with the one or more secondary windings of the one or more transformers.

11. A power converter for a vehicle, the power converter comprising:
a primary side having a line connection port and one or more primary alternating current (AC) to AC converters, wherein the line connection port further comprises:
a first AC phase connection, a second AC phase connection, a third AC phase connection, a neutral AC connection, and a plurality of electrically controllable switches in electrical communication with the first AC phase connection, the second AC phase connection, the third AC phase connection, and the neutral AC connection;
a secondary side having one or more secondary alternating current (AC) to direct current (DC) converters and one or more load connection ports, wherein at least one of the one or more load connection ports in electrical communication with a battery of the vehicle; and
a transformer configured to transfer power between the primary side and the secondary side.

12. The power converter of claim 11, the one or more primary AC to AC converters further comprising a single primary AC to AC converter having four single converter line ports and two single converter load ports, wherein:
a first of the four single converter line ports is connected to the first AC phase connection;
a second of the four single converter line ports is connected to the second AC phase connection;
a third of the four single converter line ports is connected to the third AC phase connection;
a fourth of the four single converter line ports is connected to the neutral AC connection; and
the two single converter load ports are connected to one or more primary windings of the transformer.

13. The power converter of claim 12, wherein:
the first of the four single converter line ports is connected to the first AC phase connection via a first of the plurality of electrically controllable switches;
the second of the four single converter line ports is connected to the second AC phase connection via a second of the plurality of electrically controllable switches;
the third of the four single converter line ports is connected to the third AC phase connection via a third of the plurality of electrically controllable switches;
the fourth of the four single converter line ports is connected to the neutral AC connection via a fourth of the plurality of electrically controllable switches;
a fifth of the plurality of electrically controllable switches is connected between the first of the four single converter line ports and the second of the four single converter line ports; and
a sixth of the plurality of electrically controllable switches is connected between the third of the four single converter line ports and the fourth of the four single converter line ports.

14. The power converter of claim 11, the one or more primary AC to AC converters further comprising:
a first primary AC to AC converter having two first converter line ports and two first converter load ports, wherein a first of the two first converter line ports is connected to the first AC phase connection, wherein a second of the two first converter line ports is connected to the neutral AC connection, and wherein the two first converter load ports are connected to one or more primary windings of the transformer;
a second primary AC to AC converter having two second converter line ports and two second converter load ports, wherein a first of the two second converter line ports is connected to the second AC phase connection, wherein a second of the two second converter line ports is connected to the neutral AC connection, and wherein the two second converter load ports are connected to the one or more primary windings of the transformer; and
a third primary AC to AC converter having two third converter line ports and two third converter load ports, wherein a first of the two third converter line ports is connected to the third AC phase connection, wherein a second of the two third converter line ports is connected to the neutral AC connection, and wherein the two third converter load ports are connected to the one or more primary windings of the transformer.

15. The power converter of claim 14, wherein:
the first of the two first converter line ports is connected to the first AC phase connection via a first of the plurality of electrically controllable switches;
the first of the two second converter line ports is connected to the second AC phase connection via a second of the plurality of electrically controllable switches;
the first of the two third converter line ports is connected to the third AC phase connection via a third of the plurality of electrically controllable switches;
the first of the two first converter line ports is connected to the first of the two second converter line ports via a fourth of the plurality of electrically controllable switches;
the first of the two first converter line ports is connected to the first of the two third converter line ports via a fifth of the plurality of electrically controllable switches; and
the second of the two first converter line ports, the second of the two second converter line ports, and the second of the two third converter line ports are connected to the neutral AC connection via a sixth of the plurality of electrically controllable switches.

16. The power converter of claim 11, the one or more secondary AC to DC converters further comprising:
one or more rectifiers, wherein an AC side of each of the one or more rectifiers is connected to one or more secondary windings of the transformer, and wherein a DC side of each of the one or more rectifiers is connected to one or more DC load connections of the one or more load connection ports.

17. The power converter of claim 11, the secondary side further comprising:
one or more AC to AC converters, wherein a first side of each of the one or more AC to AC converters is connected to one or more secondary windings of the transformer, wherein a second side of each of the one or more AC to AC converters is connected to one or more AC load connections of the one or more load connection ports, and wherein the one or more AC load connections are in electrical communication with one or more external AC loads or sources.

18. An on-board charging module (OBCM) for a vehicle, the OBCM comprising:
a primary side having a line connection port and a plurality of bi-directional semiconductor switches, wherein the line connection port further comprises:
a first AC phase connection, a second AC phase connection, a third AC phase connection, a neutral AC connection, and a plurality of electrically controllable switches in electrical communication with the first AC phase connection, the second AC phase connection, the third AC phase connection, and the neutral AC connection;
wherein the plurality of bi-directional semiconductor switches includes one or more bi-directional switch pairs, and wherein the one or more bi-directional switch pairs further comprise:
a first bi-directional switch pair having a first switch pair common node in electrical communication with the first AC phase connection;
a second bi-directional switch pair having a second switch pair common node in electrical communication with the second AC phase connection;
a third bi-directional switch pair having a third switch pair common node in electrical communication with the third AC phase connection; and
a fourth bi-directional switch pair having a fourth switch pair common node in electrical communication with the neutral AC connection;
a secondary side having one or more alternating current (AC) to direct current (DC) converters, one or more AC to AC converters, and one or more load connection ports, wherein at least one of the one or more load connection ports in electrical communication with a battery of the vehicle, wherein at least one of the one or more load connection ports is configured to provide a high-voltage DC output, wherein at least one of the one or more load connection ports is configured to provide a low-voltage DC output, and wherein at least one of the one or more load connection ports is configured to provide one or more AC outputs; and
a transformer configured to transfer power between the primary side and the secondary side, wherein the transformer includes one or more magnetic cores, one or more primary windings, and one or more secondary windings, and wherein one of the one or more primary windings is in electrical communication with each of the one or more bi-directional switch pairs.

19. The OBCM of claim 18, the plurality of electrically controllable switches further comprising:
a first electrically controllable switch connected between the first AC phase connection and the first switch pair common node;
a second electrically controllable switch connected between the second AC phase connection and the second switch pair common node;
a third electrically controllable switch connected between the third AC phase connection and the third switch pair common node;
a fourth electrically controllable switch connected between the neutral AC connection and the fourth switch pair common node;
a fifth electrically controllable switch connected between the first switch pair common node and the second switch pair common node; and
a sixth electrically controllable switch connected between the third switch pair common node and the fourth switch pair common node.

20. The OBCM of claim 19, further comprising a controller in electrical communication with each of the plurality of electrically controllable switches, wherein to configure the OBCM for single phase line connection, the controller is programmed to:
close the first electrically controllable switch, open the second electrically controllable switch, open the third electrically controllable switch, close the fourth electrically controllable switch, close the fifth electrically controllable switch, and close the sixth electrically controllable switch; and
wherein to configure the OBCM for three phase line connection, the controller is further programmed to:
close the first electrically controllable switch, close the second electrically controllable switch, close the third electrically controllable switch, close the fourth electrically controllable switch, open the fifth electrically controllable switch, and open the sixth electrically controllable switch.
